(19) United States
(12) Patent Application Publication
(10) Pub. No.: US 2022/0298299 A1
(43) Pub. Date: Sep. 22, 2022

(54) RING-OPENING POLYMERIZATION METHOD FOR CYCLIC MONOMER

(71) Applicant: NANJING TECH. UNIVERSITY, Nanjing, Jiangsu (CN)

(72) Inventors: Kai GUO, Nanjing, Jiangsu (CN); Zhiwei YAO, Nanjing, Jiangsu (CN); Zhenjiang LI, Nanjing, Jiangsu (CN); Chan ZHANG, Nanjing, Jiangsu (CN); Yuejia ZHU, Nanjing, Jiangsu (CN); Lei ZHANG, Nanjing, Jiangsu (CN); Zikun LUO, Nanjing, Jiangsu (CN)

(21) Appl. No.: 17/639,416

(22) PCT Filed: Sep. 8, 2020
(86) PCT No.: PCT/CN2020/113870

§ 371 Date: Mar. 1, 2022

(30) Foreign Application Priority Data
Jun. 1, 2020 (CN) 202010485793.6

(51) Int. Cl. C08G 63/82; C08G 63/08; C08G 64/30; C08G 65/04

(52) U.S. Cl. CPC C08G 63/823; C08G 63/08; C08G 64/30; C08G 65/04; C08G 2230/00

(57) ABSTRACT

The present disclosure belongs to the field of organic synthesis, and particularly relates to a ring-opening polymerization method for a cyclic monomer. A specific solution is that a Lewis acid-base pair is used to catalyze ring-opening polymerization of the cyclic monomer in the presence of an initiator. By using the Lewis acid-base pair as a catalyst, on one hand, a range of a ring-opening polymerization catalyst is widened, and on the other hand, this catalyst achieves a higher catalytic efficiency and is milder in comparison with previously reported strong acid or strong base catalysts. In addition, through a bifunctional activation mechanism, this catalyst system activates the monomer and simultaneously activates the initiator or a chain end, and has the characteristics of high efficiency in comparison with the reported monomer activation mechanism or chain end activation mechanism. By adopting the catalyst, a polyester product with a target molecular weight can be synthesized in a controlled manner as required, with a narrower molecular weight distribution index, a high product yield, a high product conversion rate and no monomer or metal residues.

### TECHNICAL FIELD

The present disclosure belongs to the technical field of green catalytic synthesis, and particularly relates to a ring-opening polymerization method for a cyclic monomer.

### BACKGROUND

Biodegradable polymer materials can be divided into natural polymer materials and synthetic polymer materials according to sources thereof. Wherein, the natural polymer materials mainly include polysaccharides and proteins, including natural high polymers such as chitin, hyaluronic acid, collagen and fibrin which can be directly obtained from organisms and deviated from a wide range of sources; and the synthetic polymer materials include biological synthetic materials and chemical synthetic materials. Compared with the natural polymer materials, the synthetic polymer materials can be physically and chemically modified according to application fields of the materials, so that the properties of the materials are more applicable to uses of the materials.

Among a variety of synthetic polymer materials, aliphatic polyesters occupy an important position due to their excellent biodegradability, bioabsorbability and biocompatibility, and have become a research hotspot in recent years. A main chain of an aliphatic polyester is formed by connecting aliphatic structural units through ester bonds which are easy to hydrolyze, and is easily degraded into nontoxic water-soluble oligomers or monomers by a large number of microorganisms in nature or enzymes in animals and plants, and then the nontoxic water-soluble oligomers or monomers are oxidized into carbon dioxide and water and release energy. Aliphatic polyesters are mainly applied to the fields such as medical surgical sutures, drug carriers and biological tissue engineering. At present, the most widely studied polyesters with a commercial value mainly include poly-ε-caprolactone, polylactide, polyglycolide, poly-β-butyrolactone, polytrimethylene carbonate, etc.

Polycondensation is an important method for preparing aliphatic polyesters. This synthetic method has the advantages of low raw material cost, pure polymerization products, no medium separation, etc. However, a product has a low molecular weight and wide molecular weight distribution and is not beneficial to the stability of a material. With the increasing demand of medical materials and nano-materials, requirements on material quality and performance have been improved, and the shortcomings such as metal residues of metal catalysts and difficulty in preparing enzyme catalysts have been unable to meet the new requirements.

### SUMMARY

To solve the above problems, the present disclosure provides a ring-opening polymerization method for a cyclic monomer, which has the advantages of a controllable molecular weight, narrow molecular weight distribution and no metal residues in polymerization products, and meets the biosafety requirements of general resins, textile materials and food packaging materials.

To solve the above technical problems, the present disclosure adopts a specific solution as follows:

A ring-opening polymerization method for a cyclic monomer is provided, wherein a Lewis acid-base pair is used to catalyze ring-opening polymerization of the cyclic monomer in the presence of an initiator; the Lewis acid is shown in a formula IV, and the Lewis base is triphenylamine:

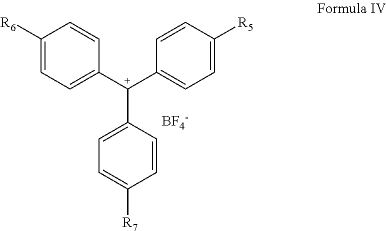

wherein, R₅, R₆ and R₇ are selected from the same or different substituents in hydrogen, fluorine, methyl or methoxyl.

Preferably, the cyclic monomer is selected from cyclic lactone, cyclic carbonate or cyclic ether.

Preferably, the cyclic monomer is selected from cyclic lactone shown in a formula V:

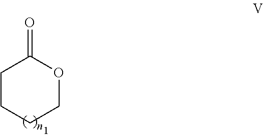

wherein n₁ is an integer selected from 1 to 8;

or the cyclic monomer is selected from cyclic carbonate shown in a formula VI:

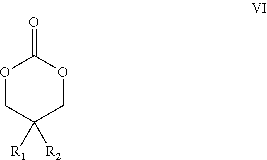

wherein, R₁ and R₂ are selected from the same or different substituents in hydrogen, methyl, fluorine, chlorine and bromine;
or the cyclic monomer is selected from cyclic ether shown in a formula VII:

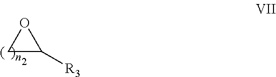

wherein, n₂ is an integer from 1 to 3, and R₃ is selected from hydrogen, methyl, tert-butyl, phenyl or —CH₂OCH₃.

Preferably, the initiator is selected from primary alcohol.

Preferably, the initiator is selected from primary alcohol shown in a formula VIII:

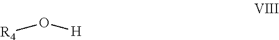

wherein R₄ is selected from benzyl, phenylpropyl, neopentyl or n-pentyl.

Preferably, ring-opening polymerization conditions for the cyclic monomer are as follows: a reaction is carried out in the presence of an organic solvent or in the absence of a solvent in an anhydrous and oxygen-free environment, and a polymer is precipitated by using a precipitation solvent after the reaction is ended,

wherein, a reaction temperature is 20° C. to 110° C. when the reaction is carried out in the presence of the organic solvent, and a reaction temperature is 80° C. to 200° C. when the reaction is carried out in the absence of the solvent.

Preferably, when the reaction is carried out in the presence of the organic solvent, when the organic solvent is dichloromethane, the reaction temperature is 20° C. to 30° C.; when the organic solvent is methylbenzene, the reaction temperature is 20° C. to 110° C.; and when the organic solvent is acetonitrile, the reaction temperature is 20° C. to 80° C.

Preferably, a molar ratio of the cyclic monomer to the Lewis acid to the triphenylamine to the initiator is (30-500):1:1:1.

Preferably, a preparation method of the Lewis acid shown in the formula IV includes the following steps:

(1) reacting aryl magnesium bromide shown in a formula I with diaryl ketone shown in a formula II in an organic solvent at 30° C. to 70° C. to obtain triarylmethanol shown in a formula III:

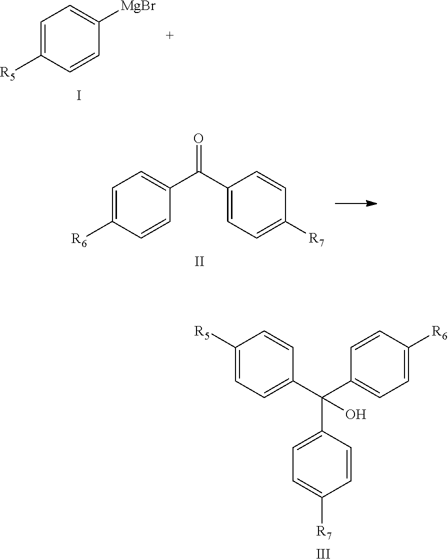

wherein, R₅, R₆ and R₇ are selected from the same or different substituents in hydrogen, fluorine, methyl or methoxyl; and
(2) reacting the product triarylmethanol obtained in the step (1) with HBF₄.Et₂O to obtain the Lewis acid shown in the formula IV.

Preferably, the diaryl ketone shown in the formula II is selected from:

| NO. | Structure |
|---|---|
| 1 | 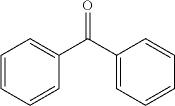 [SMILES: O=C(c1ccccc1)c1ccccc1] |
| 2 | 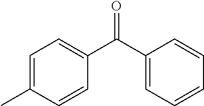 |
| 3 | 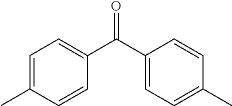 |
| 4 | 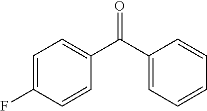 [SMILES: O=C(c1ccccc1)c1ccc(F)cc1] |
| 5 | 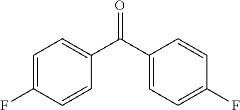 [SMILES: O=C(c1ccc(F)cc1)c1ccc(F)cc1] |
| 6 | 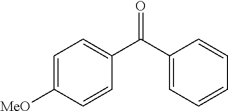 [SMILES: COc1ccc(C(=O)c2ccccc2)cc1] |
| 7 | 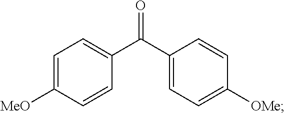 [SMILES: COc1ccc(C(=O)c2ccc(OC)cc2)cc1] |

and
the triarylmethanol shown in the formula III is selected from:

| NO. | Structure |
|---|---|
| 8 | 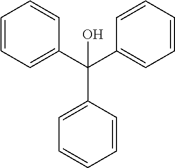 [SMILES: OC(c1ccccc1)(c1ccccc1)c1ccccc1] |
| 9 | 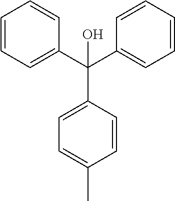 [SMILES: Cc1ccc(C(O)(c2ccccc2)c2ccccc2)cc1] |
| 10 | 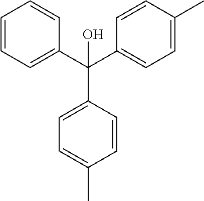 [SMILES: Cc1ccc(C(O)(c2ccccc2)c2ccc(C)cc2)cc1] |
| 11 | 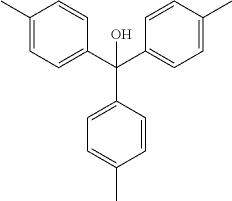 |
| 12 | 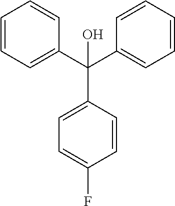 [SMILES: OC(c1ccccc1)(c1ccccc1)c1ccc(F)cc1] |
| 13 | 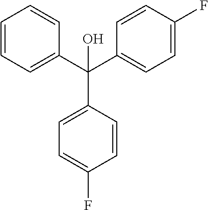 [SMILES: OC(c1ccccc1)(c1ccc(F)cc1)c1ccc(F)cc1] |
| 14 | 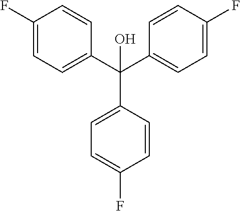 [SMILES: OC(c1ccc(F)cc1)(c1ccc(F)cc1)c1ccc(F)cc1] |
| 15 | 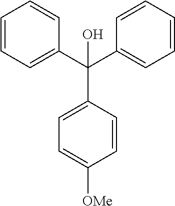 [SMILES: COc1ccc(C(O)(c2ccccc2)c2ccccc2)cc1] |
| 16 | 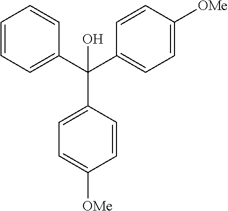 [SMILES: COc1ccc(C(O)(c2ccccc2)c2ccc(OC)cc2)cc1] |
| 17 | 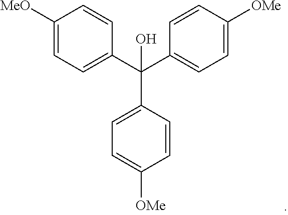 [SMILES: COc1ccc(C(O)(c2ccc(OC)cc2)c2ccc(OC)cc2)cc1] |

Preferably, the step (2) includes the following specific reaction operations: dissolving the triarylmethanol in anhydrous diethyl ether, cooling to 0° C. to 10° C., and slowly adding dropwise 1.2 to 1.5 molar equivalents of an HBF₄.Et₂O solution while stirring.

The ring-opening polymerization method for the cyclic monomer adopts a bifunctional catalytic mechanism. For example, in ring-opening polymerization of a cyclic valerolactone monomer in which benzyl alcohol is used as an initiator, a mechanism reaction formula is as follows:

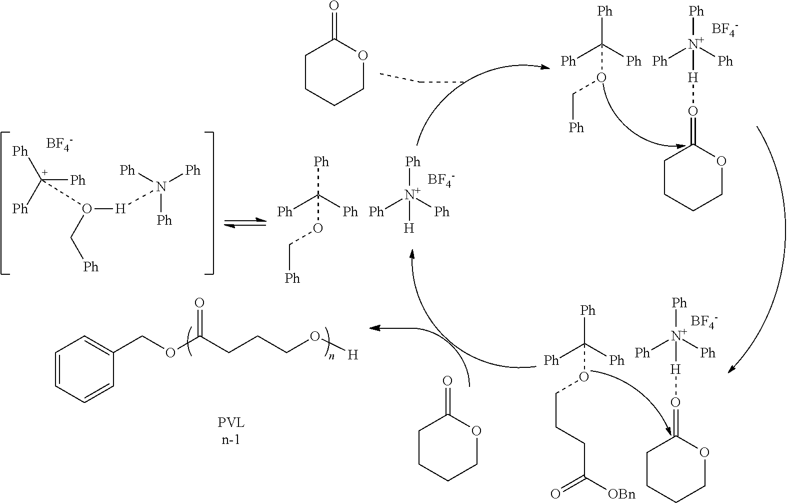

### Beneficial Effects

By adopting the technical solution of the present disclosure, at least one of the following beneficial effects can be achieved:

(1) The method of the present disclosure can synthesize a polyester (polycarbonate, polycaprolactone, and polyvalerolactone) and a polyether with a precise structure through the above catalytic system, and has wide application. The polymer has a controllable molecular weight, narrow molecular weight distribution and no chain transesterification reaction, and has a great commercial application potential in the fields of biomedicine and microelectronics.
(2) According to the present disclosure, the polyester is obtained through catalysis of the catalytic system of the Lewis acid-base pair, and this catalytic system has a higher catalytic efficiency and is milder in comparison with the previously reported strong acid or strong base catalysts.
(3) By adopting the bifunctional activation mechanism, the catalytic system activates the monomer and simultaneously activates the initiator or the chain end, and has the characteristic of high efficiency in comparison with the reported monomer activation mechanism or chain end activation mechanism.
(4) According to this method, a polyester product with a target molecular weight can be synthesized in a controlled manner as required, with a narrower molecular weight distribution index, a high product yield, a high product conversion rate and no monomer or metal residues.

In conclusion, compared with the existing catalytic system, the method of the present disclosure has obvious advantages such as mildness, high efficiency, wide sources, simple synthesis, variety of types and wide ranges.

### BRIEF DESCRIPTION OF THE DRAWINGS

FIG. 1 is an H-nuclear magnetic resonance spectrum of a carbocation Lewis acid 18 in Embodiment 1.

FIG. 2 is an H-nuclear magnetic resonance spectrum of a product polyvalerolactone in Embodiment 1.

FIG. 3 is a size exclusion chromatography of the product polyvalerolactone in Embodiment 1.

FIG. 4 is an H-nuclear magnetic resonance spectrum of a product polycaprolactone in Embodiment 2.

FIG. 5 is a size exclusion chromatography of the product polycaprolactone in Embodiment 2.

FIG. 6 is an H-nuclear magnetic resonance spectrum of a carbocation Lewis acid 19 in Embodiment 4.

FIG. 7 is an H-nuclear magnetic resonance spectrum of a carbocation Lewis acid 21 in Embodiment 8.

FIG. 8 is a C-nuclear magnetic resonance spectrum of the carbocation Lewis acid 21 in Embodiment 8.

FIG. 9 is an H-nuclear magnetic resonance spectrum of a product polytrimethylene carbonate in Embodiment 9.

FIG. 10 is an H-nuclear magnetic resonance spectrum of a carbocation Lewis acid 24 in Embodiment 13.

FIG. 11 is a C-nuclear magnetic resonance spectrum of the carbocation Lewis acid 24 in Embodiment 13.

FIG. 12 is an H-nuclear magnetic resonance spectrum of polytrimethylene carbonate in Embodiment 13.

FIG. 13 is an H-nuclear magnetic resonance spectrum of a carbocation Lewis acid 27 in Embodiment 14.

FIG. 14 is a C-nuclear magnetic resonance spectrum of the carbocation Lewis acid 27 in Embodiment 14.

FIG. 15 is an H-nuclear magnetic resonance spectrum of polytrimethylene carbonate in Embodiment 14.

FIG. 16 is an H-nuclear magnetic resonance spectrum of a product polyvalerolactone in Embodiment 18.

FIG. 17 is an H-nuclear magnetic resonance spectrum of a product polycaprolactone in Embodiment 19.

FIG. 18 is an H-nuclear magnetic resonance spectrum of a product polyoxetane in Embodiment 20.

FIG. 19 is a C-nuclear magnetic resonance spectrum of a product polytetrahydrofuran in Embodiment 21.

### DETAILED DESCRIPTION

The present disclosure can be further illustrated with the following embodiments, and the embodiments are intended to illustrate rather than to limit the present disclosure. Any person of ordinary skill in the art can understand that these embodiments are not intended to limit the present disclosure in any way, and can make appropriate modifications and data transformations without violating the essence of the present disclosure or departing from the scope of the present disclosure.

All kinds of raw materials involved in the description are purchased from markets, wherein the source and purity of some reagents and the models of instruments used are shown in the following tables:

TABLE 1
Source and Purity of Reagents

| NO. | Reagent | Purity | Source |
|---|---|---|---|
| 1 | Diethyl ether | Analytically | Sinopharm Chemical |
| | | pure | Reagent Co., Ltd. |
| 2 | Methanol | Analytically | Sinopharm Chemical |
| | | pure | Reagent Co., Ltd. |
| 3 | Dichloromethane | Analytically | Shanghai Aladdin |
| | | pure | Biochemical |
| | | | Technology Co., Ltd. |
| 4 | Tetrahydrofuran | Analytically | Shanghai Aladdin |
| | | pure | Biochemical |
| | | | Technology Co., Ltd. |
| 5 | Methylbenzene | Analytically | Sinopharm Chemical |
| | | pure | Reagent Co., Ltd. |
| 6 | ε-caprolactone | 98% | Shanghai Aladdin |
| | | | Biochemical |
| | | | Technology Co., Ltd. |
| 7 | δ-valerolactone | 98% | Shanghai Aladdin |
| | | | Biochemical |
| | | | Technology Co., Ltd. |
| 8 | Trimethylene | 97% | TCI (Shanghai) |
| | carbonate | | Development Co., Ltd. |
| 9 | Benzyl alcohol | 99% | J&K Scientific Co., Ltd. |
| 10 | Triphenylmethyl | 98% | Energy-Chemical |
| | carbocation | | Technology (Shanghai) |
| | tetrafluoroborate | | Co., Ltd. |
| 11 | Phenyl magnesium | 2 mol/L | Energy-Chemical |
| | bromide | in THF | Technology (Shanghai) |
| | | | Co., Ltd. |
| 12 | p-fluorophenyl | 1 mol/L | Energy-Chemical |
| | magnesium | in THF | Technology (Shanghai) |
| | bromide | | Co., Ltd. |
| 13 | p-methyl phenyl | 1 mol/L | Energy-Chemical |
| | magnesium | in THF | Technology (Shanghai) |
| | bromide | | Co., Ltd. |
| 14 | p-methoxy phenyl | 2 mol/L | Energy-Chemical |
| | magnesium bromide | in THF | Technology (Shanghai) |
| | | | Co., Ltd. |
| 15 | Diphenyl ketone | 98% | Shanghai Aladdin |
| | | | Biochemical |
| | | | Technology Co., Ltd. |
| 16 | 4,4′-difluorodiphenyl | 98% | Shanghai Aladdin |
| | ketone | | Biochemical |
| | | | Technology Co., Ltd. |
| 17 | Ethyl p-methyl | 97% | Energy-Chemical |
| | benzoate | | Technology (Shanghai) |
| | | | Co., Ltd. |
| 19 | Triphenylamine | 98% | J&K Scientific Co., Ltd. |

TABLE 2
Instruments and Equipment

| | Instrument | | |
|---|---|---|---|
| NO. | Name | Model NO. | Manufacturer |
| 1 | Heating | RCT Basic Type | IKA |
| | magnetic | (Safe Control | |
| | stirrer | Type) IKAMAG ® | |
| 2 | Diaphragm | ABF 63/4C-7RQ | ILMVAC Vacuum |
| | vacuum pump | | Equipment Co.,Ltd. |
| 3 | Rotary | RV 10 control V | IKA |
| | evaporator | | |
| 4 | Vacuum drying | DZF-6050 | Shanghai Jinghong |
| | oven | | Experimental |
| | | | Equipment Co., Ltd. |
| 5 | Glove box | LS800S | Chengdu Dellix |
| | | | (Industry) Co., Ltd. |
| 6 | Electronic | FA1104N | Shanghai Precision |
| | scale | | Scientific Instruments |
| | | | Co., Ltd. |
| 7 | Desktop | TD25-WS | Xiangyi Centrifuge |
| | high-speed | | Instrument Co., Ltd. |
| | centrifuge | | |
| 8 | Nuclear | Bruker Ascend | Test Center of College |
| | magnetic | TM-400 | of Biotechnology and |
| | resonance | | Pharmaceutical Engineering |
| | spectrometer | | of Nanjing Tech University |

The triaryl carbocation tetrafluoroborate, namely the carbocation Lewis acid, used in the embodiments is shown in the following table:

| NO. | Structure |
|---|---|
| 18 | 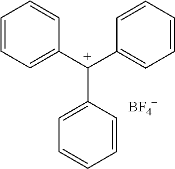 |
| 19 | 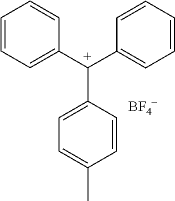 |
| 21 | 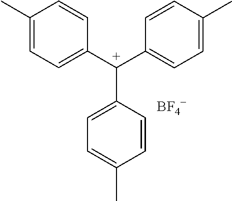 |
| 24 | 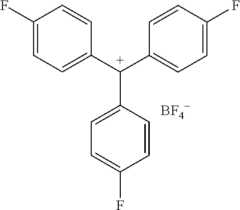 |
| 27 | 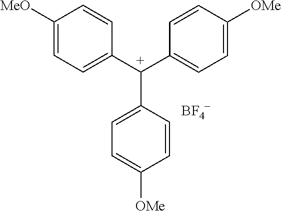 |

### Embodiment 1

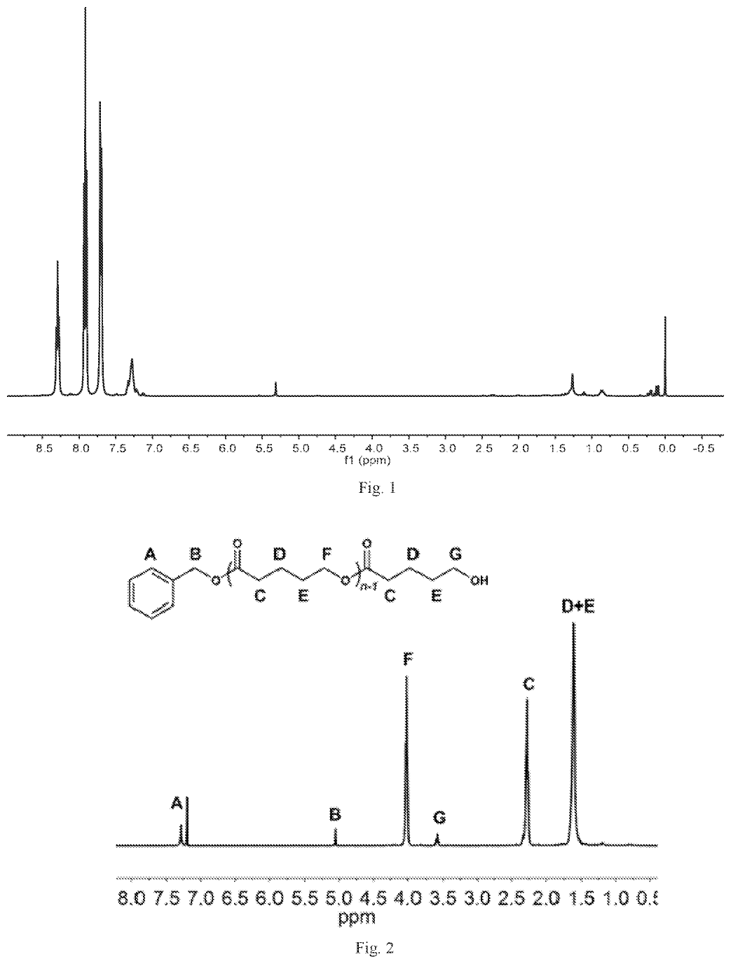

The carbocation Lewis acid 18 was prepared as follows: under the protection of an anhydrous inert gas, 2.8 g (15.4 mmol) of diphenyl ketone and 23.1 ml of phenyl magnesium bromide (with a molar concentration of 1 mol/L in tetrahydrofuran) were subjected to a reaction at 60° C. with anhydrous tetrahydrofuran as a solvent; the reaction was completed after 2 h; 0.54 ml (30 mmol) of water was added to quench the reaction; and aftertreatments such as rotary evaporation, drying and recrystallization were performed to obtain 2.5 g of triphenylmethanol, with a yield of 62.5%. 2.5 g (9.6 mmol) of triphenylmethanol was dissolved in anhydrous diethyl ether and an obtained solution was cooled to 0° C.; 2.1 ml (14.4 mmol) of a tetrafluoroboric acid-diethyl ether complex was dropwise added into the reaction, so that a yellow solid precipitate was precipitated immediately; and the yellow solid precipitate was filtered and dried to obtain 2.7 g of carbocation Lewis acid 18, wherein a hydrogen spectrum structure of the carbocation Lewis acid 18 is shown in FIG. 1.

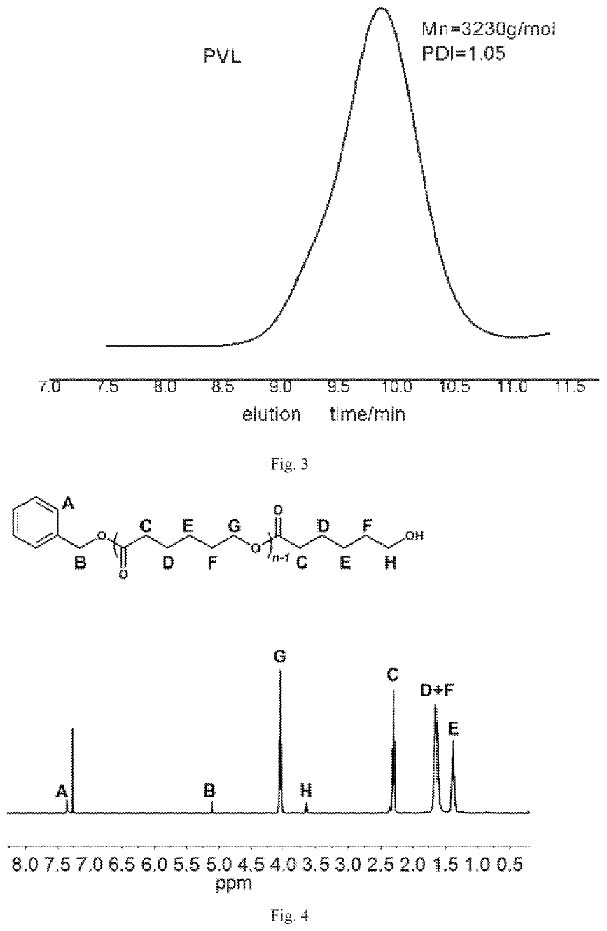

δ-valerolactone (0.27 ml, 3 mmol), the carbocation Lewis acid 18 (0.033 g, 0.1 mmol), triphenylamine (0.0245 g, 0.1 mmol) and benzyl alcohol (10.3 μL, 0.1 mmol) were added to a 10 mL polymerization tube, and finally 1 mL of acetonitrile was added as a solvent; the reaction was stopped after the mixture was magnetically stirred at 80° C. for 1.5 h; an obtained solution was slowly dropwise added to rectisol, so that a white polymer was precipitated; and the white polymer was centrifuged and dried in vacuum to obtain 0.25 g of a snow-white product, wherein a conversion rate was 95%, a number average molecular weight Mₙ of polyvalerolactone was 3.2 kg/mol, and molecular weight distribution PDI was 1.05. A hydrogen spectrum of the product is shown in FIG. 2, and a size exclusion chromatogram of the product is shown in FIG. 3.

### Embodiment 2

The carbocation Lewis acid 18 was prepared as in Embodiment 1.

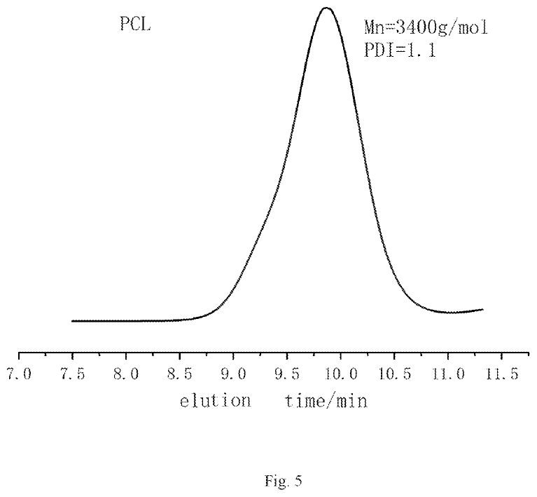

ε-caprolactone (0.33 ml, 3 mmol), the carbocation Lewis acid 18 (0.033 g, 0.1 mmol), triphenylamine (0.0245 g, 0.1 mmol) and benzyl alcohol (10.3 μL, 0.1 mmol) were added to a 10 mL polymerization tube, and finally 1 mL of dichloromethane was added as a solvent; the reaction was stopped after the mixture was magnetically stirred at 30° C. for 2.5 h; an obtained solution was slowly dropwise added to rectisol, so that a white polymer was precipitated; and the white polymer was centrifuged and dried in vacuum to obtain 0.32 g of a snow-white product, wherein a conversion rate was 95%, a number average molecular weight Mₙ of polycaprolactone was 3.4 kg/mol, and molecular weight distribution PDI was 1.10. A hydrogen spectrum of the product is shown in FIG. 4, and a size exclusion chromatogram of the product is shown in FIG. 5.

### Embodiment 3

The carbocation Lewis acid 18 was prepared as in Embodiment 1.

Trimethylene carbonate (0.3063 g, 3 mmol), the carbocation Lewis acid 18 (0.033 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 60° C. for 2.5 h; an obtained solution was slowly dropwise added to rectisol, so that a colorless and transparent oily substance was precipitated; and the colorless and transparent oily substance was centrifuged and dried in vacuum to obtain 0.29 g of a colorless and transparent sticky substance, wherein a conversion rate was 95%, a number average molecular weight Mₙ of polytrimethylene carbonate was 3.2 kg/mol, and molecular weight distribution PDI was 1.15.

### Embodiment 4

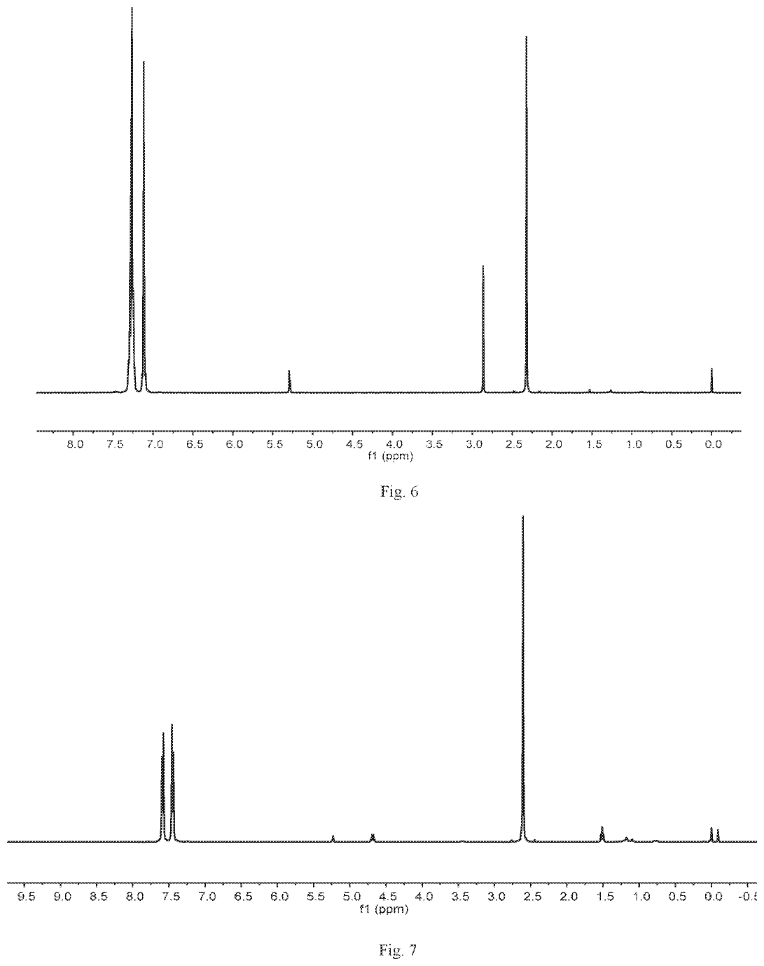

The carbocation Lewis acid 19 was prepared as follows: under the protection of an anhydrous inert gas, 2.7 g (15.4 mmol) of diphenyl ketone and 22 ml of 4-methyl phenyl magnesium bromide (with a molar concentration of 1 mol/L in tetrahydrofuran) were subjected to a reaction at 60° C. with anhydrous tetrahydrofuran as a solvent; the reaction was completed after 2 h; 0.54 ml (30 mmol) of water was added to quench the reaction; and aftertreatments such as rotary evaporation, drying and recrystallization were performed to obtain 2.6 g of 4-methyl phenyl diphenylmethanol, with a yield of 62.8%. 2.6 g (9.6 mmol) of 4-methyl phenyl diphenylmethanol was dissolved in anhydrous diethyl ether and an obtained solution was cooled to 0° C.; 2.1 ml (14.4 mmol) of a tetrafluoroboric acid-diethyl ether complex was dropwise added in the reaction, so that a yellow solid precipitate was precipitated immediately; and the yellow solid precipitate was filtered and dried to obtain 2.8 g of carbocation Lewis acid 19, wherein a hydrogen spectrum structure of the carbocation Lewis acid 19 is shown in FIG. 6.

δ-valerolactone (0.27 ml, 3 mmol), the carbocation Lewis acid 19 (0.0384 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 60° C. for 2 h; an obtained solution was slowly dropwise added to rectisol, so that a white polymer was precipitated; and the white polymer was centrifuged and dried in vacuum to obtain 0.26 g of a snow-white product, wherein a conversion rate was 96%, a number average molecular weight Mₙ of polyvalerolactone was 3.2 kg/mol, and molecular weight distribution PDI was 1.09.

### Embodiment 5

The carbocation Lewis acid 19 was prepared as in Embodiment 4.

ε-caprolactone (0.33 ml, 3 mmol), the carbocation Lewis acid 19 (0.0384 g, 0.1 mmol), triphenylamine (0.0245 g, 0.1 mmol) and benzyl alcohol (10.3 μL, 0.1 mmol) were added to a 10 mL polymerization tube, and finally 1 mL of dichloromethane was added as a solvent; the reaction was stopped after the mixture was magnetically stirred at 20° C. for 3 h; an obtained solution was slowly dropwise added to rectisol, so that a white polymer was precipitated; and the white polymer was centrifuged and dried in vacuum to obtain 0.33 g of a snow-white product, wherein a conversion rate was 94%, a number average molecular weight Mₙ of polycaprolactone was 3.4 kg/mol, and molecular weight distribution PDI was 1.10.

### Embodiment 6

The carbocation Lewis acid 19 was prepared as in Embodiment 4.

Trimethylene carbonate (0.3063 g, 3 mmol), the carbocation Lewis acid 19 (0.0384 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 60° C. for 4 h; an obtained solution was slowly dropwise added to rectisol, so that a colorless and transparent oily substance was precipitated; and the colorless and transparent oily substance was centrifuged and dried in vacuum to obtain 0.29 g of a colorless and transparent sticky substance, wherein a conversion rate was 95%, a number average molecular weight Mₙ of polytrimethylene carbonate was 3.4 kg/mol, and molecular weight distribution PDI was 1.14.

### Embodiment 7

The carbocation Lewis acid 19 was prepared as in Embodiment 4.

δ-valerolactone (0.27 ml, 3 mmol), the carbocation Lewis acid 19 (0.0372 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 80° C. for 2.5 h; an obtained solution was slowly dropwise added to rectisol, so that a white polymer was precipitated; and the white polymer was centrifuged and dried in vacuum to obtain 0.27 g of a snow-white product, wherein a conversion rate was 96%, a number average molecular weight Mₙ of polyvalerolactone was 3.2 kg/mol, and molecular weight distribution PDI was 1.09.

### Embodiment 8

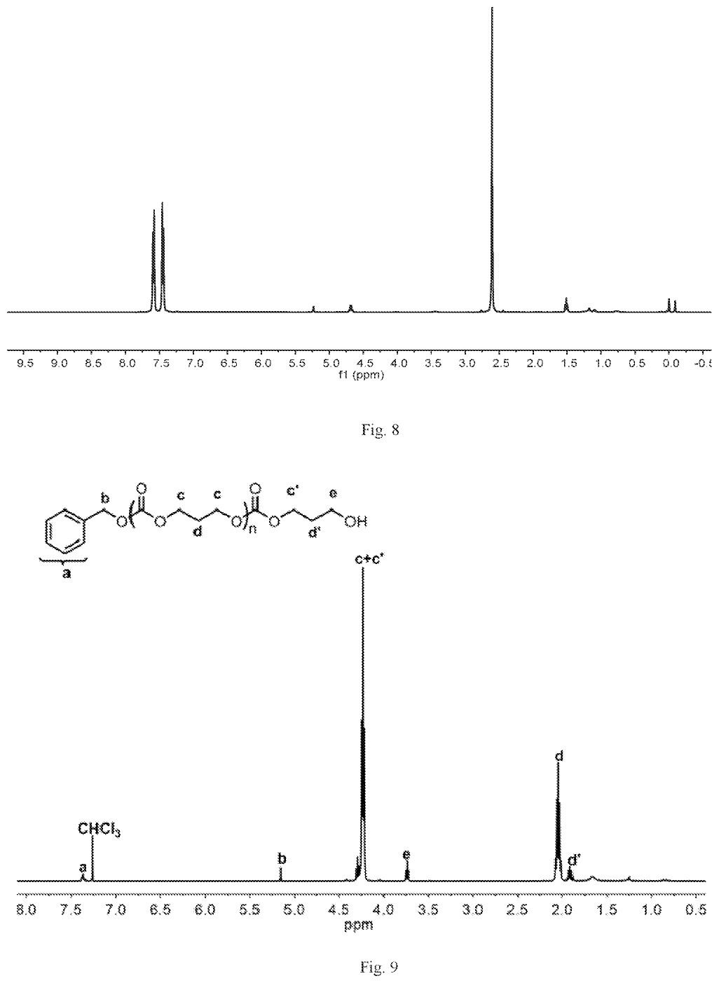

The carbocation Lewis acid 21 was prepared as follows: under the protection of an anhydrous inert gas, 2.5 g (14.3 mmol) of 4,4′-dimethyl diphenyl ketone and 19 ml of phenyl magnesium bromide (with a molar concentration of 1 mol/L in tetrahydrofuran) were subjected to a reaction at 50° C. with anhydrous tetrahydrofuran as a solvent; the reaction was completed after 2 h; 0.8 ml (40 mmol) of water was added to quench the reaction; and aftertreatments such as rotary evaporation, drying and recrystallization were performed to obtain 2.5 g of 4,4′,4″-trimethyl triphenylmethanol, with a yield of 62.5%. 2.7 g (9.7 mmol) of 4,4′,4″-trimethyl triphenylmethanol was dissolved in anhydrous diethyl ether and an obtained solution was cooled to 0° C.; 2.5 ml (15.4 mmol) of a tetrafluoroboric acid-diethyl ether complex was dropwise added in the reaction, so that a yellow solid precipitate was precipitated immediately; and the yellow solid precipitate was filtered and dried to obtain 2.9 g of carbocation Lewis acid 21, wherein a hydrogen spectrum structure of the carbocation Lewis acid 21 is shown in FIG. 7, and a carbon spectrum structure of the carbocation Lewis acid 21 is shown in FIG. 8.

ε-caprolactone (0.33 ml, 3 mmol), the carbocation Lewis acid 21 (0.0385 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 50° C. for 3.5 h; an obtained solution was slowly dropwise added to rectisol, so that a white polymer was precipitated; and the white polymer was centrifuged and dried in vacuum to obtain 0.33 g of a snow-white product, wherein a conversion rate was 96%, a number average molecular weight Mₙ of polycaprolactone was 3.4 kg/mol, and molecular weight distribution PDI was 1.11.

### Embodiment 9

The carbocation Lewis acid 21 was prepared as in Embodiment 8.

Trimethylene carbonate (0.3063 g, 3 mmol), the carbocation Lewis acid 21 (0.0385 g, 0.1 mmol), triphenylamine (0.0245 g, 0.1 mmol) and benzyl alcohol (10.3 μL, 0.1 mmol) were added to a 10 mL polymerization tube, and finally 1 mL of acetonitrile was added as a solvent; the reaction was stopped after the mixture was magnetically stirred at 70° C. for 4.5 h; an obtained solution was slowly dropwise added to rectisol, so that a colorless and transparent sticky substance was precipitated; and the colorless and transparent sticky substance was centrifuged and dried in vacuum to obtain 0.31 g of a colorless and transparent sticky substance, wherein a conversion rate was 97%, a number average molecular weight Mₙ of polytrimethylene carbonate was 3.4 kg/mol, and molecular weight distribution PDI was 1.15; and a ¹H NMR spectrum of the product polytrimethylene carbonate is shown in FIG. 9.

### Embodiment 10

The carbocation Lewis acid 21 was prepared as in Embodiment 8.

δ-valerolactone (0.27 ml, 3 mmol), the carbocation Lewis acid 21 (0.0385 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 90° C. for 16 h; an obtained solution was slowly dropwise added to rectisol, so that a white polymer was precipitated; and the white polymer was centrifuged and dried in vacuum to obtain 0.19 g of a snow-white product, wherein a conversion rate was 90%, a number average molecular weight Mₙ of polyvalerolactone was 2.9 kg/mol, and molecular weight distribution PDI was 1.04.

### Embodiment 11

The carbocation Lewis acid 21 was prepared as in Embodiment 8.

ε-caprolactone (0.33 ml, 3 mmol), the carbocation Lewis acid 21 (0.0385 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 70° C. for 24 h; an obtained solution was slowly dropwise added to rectisol, so that a white polymer was precipitated; and the white polymer was centrifuged and dried in vacuum to obtain 0.25 g of a snow-white product, wherein a conversion rate was 80%, a number average molecular weight Mₙ of polycaprolactone was 2.6 kg/mol, and molecular weight distribution PDI was 1.06.

### Embodiment 12

The carbocation Lewis acid 21 was prepared as in Embodiment 8.

Trimethylene carbonate (0.3063 g, 3 mmol), the carbocation Lewis acid 21 (0.0385 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 80° C. for 24 h; an obtained solution was slowly dropwise added to rectisol, so that a colorless and transparent oily substance was precipitated; and the colorless and transparent oily substance was centrifuged and dried in vacuum to obtain 0.22 g of a colorless and transparent sticky substance, wherein a conversion rate was 75%, a number average molecular weight Mₙ of polytrimethylene carbonate was 2.2 kg/mol, and molecular weight distribution PDI was 1.09.

### Embodiment 13

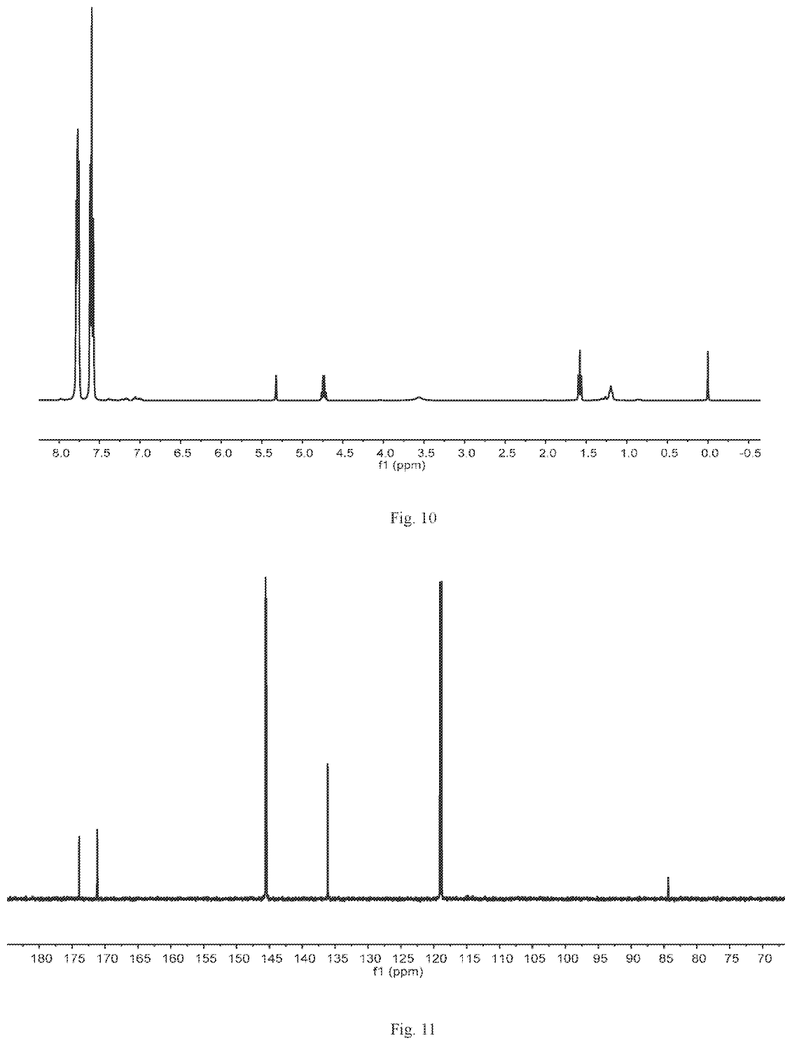

The carbocation Lewis acid 24 was prepared as follows: under the protection of an anhydrous inert gas, 2.9 g (15.3 mmol) of 4,4′-difluorodiphenyl ketone and 23.7 ml of phenyl magnesium bromide (with a molar concentration of 1 mol/L in tetrahydrofuran) were subjected to a reaction at 70° C. with anhydrous tetrahydrofuran as a solvent; the reaction was completed after 2 h; 0.8 ml (40 mmol) of water was added to quench the reaction; and aftertreatments such as rotary evaporation, drying and recrystallization were performed to obtain 2.5 g of 4,4′,4″-trifluorotriphenylmethanol, with a yield of 62.5%. 2.7 g (9.7 mmol) of 4,4′,4″-trifluorotriphenylmethanol was dissolved in anhydrous diethyl ether and an obtained solution was cooled to 0° C.; 2.5 ml (15.4 mmol) of a tetrafluoroboric acid-diethyl ether complex was dropwise added in the reaction, so that a yellow solid precipitate was precipitated immediately; and the yellow solid precipitate was filtered and dried to obtain 2.9 g of carbocation Lewis acid 24, wherein a hydrogen spectrum structure of the carbocation Lewis acid 24 is shown in FIG. 10, and a carbon spectrum structure of carbocation Lewis acid 24 is shown in FIG. 11.

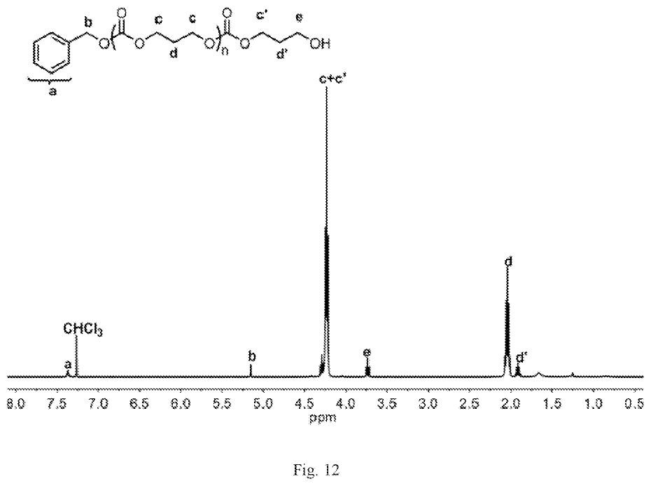

Trimethylene carbonate (0.3063 g, 3 mmol), the carbocation Lewis acid 24 (0.0420 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 100° C. for 24 h; an obtained solution was slowly dropwise added to rectisol, so that a colorless and transparent oily substance was precipitated; and the colorless and transparent oily substance was centrifuged and dried in vacuum to obtain 0.22 g of a colorless and transparent sticky substance, wherein a conversion rate was 75%, a number average molecular weight Mₙ of polytrimethylene carbonate was 2.2 kg/mol, and molecular weight distribution PDI was 1.09; and a hydrogen spectrum is shown in FIG. 12.

### Embodiment 14

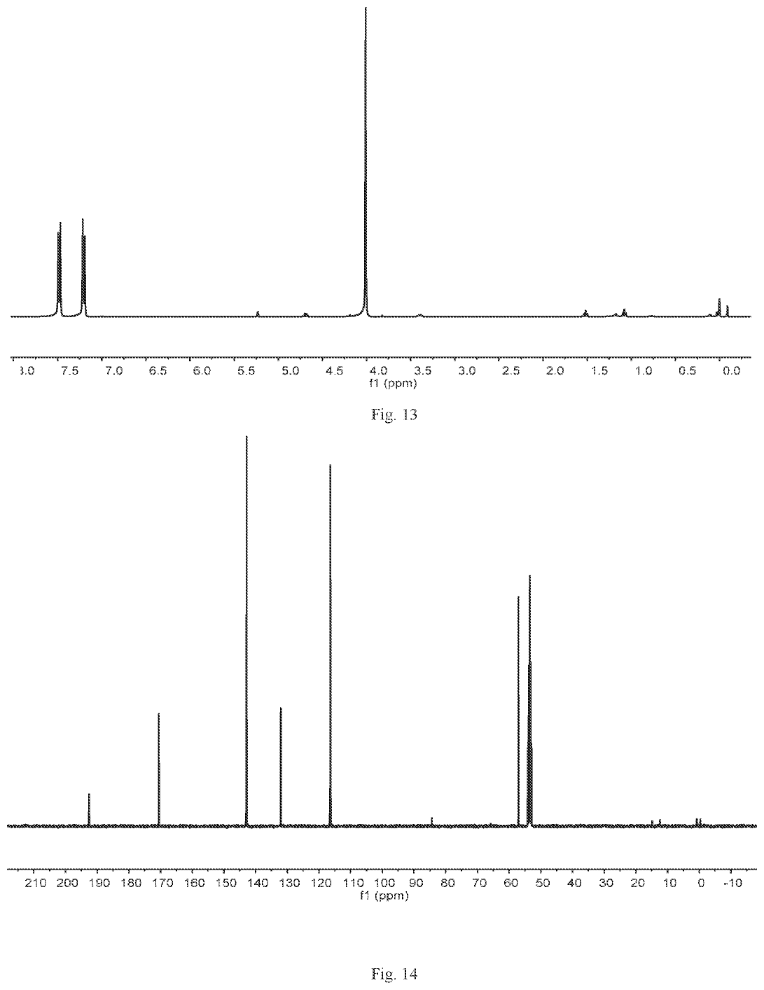

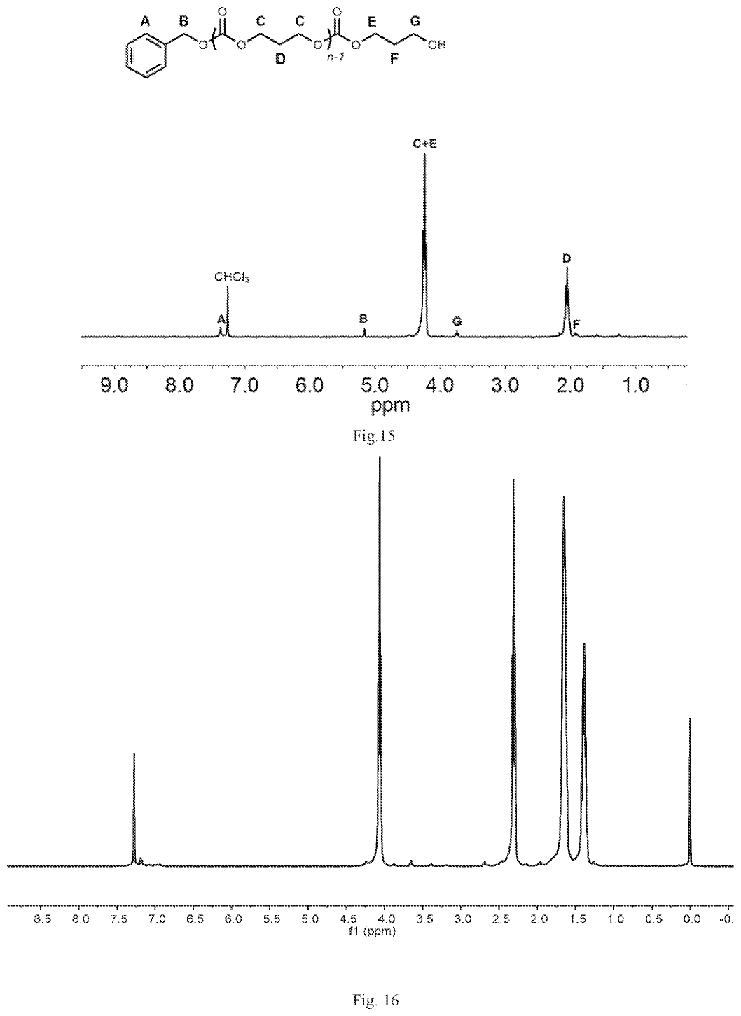

The carbocation Lewis acid 27 was prepared as follows: under the protection of an anhydrous inert gas, 2.9 g (15.3 mmol) of 4,4′-dimethoxydiphenyl ketone and 23.7 ml of phenyl magnesium bromide (with a molar concentration of 1 mol/L in tetrahydrofuran) were subjected to a reaction at 60° C. with anhydrous tetrahydrofuran as a solvent; the reaction was completed after 2 h; 0.8 ml (40 mmol) of water was added to quench the reaction; and aftertreatments such as rotary evaporation, drying and recrystallization were performed to obtain 2.5 g of 4,4′,4″-trimethoxytriphenylmethanol, with a yield of 62.5%. 2.7 g (9.7 mmol) of 4,4′,4″-trimethoxytriphenylmethanol was dissolved in anhydrous diethyl ether and an obtained solution was cooled to 0° C.; 2.5 ml (15.4 mmol) of a tetrafluoroboric acid-diethyl ether complex was dropwise added in the reaction, so that a yellow solid precipitate was precipitated immediately; and the yellow solid precipitate was filtered and dried to obtain 2.9 g of carbocation Lewis acid 27 was obtained, wherein a hydrogen spectrum structure of the carbocation Lewis acid 27 is shown in FIG. 13, and a carbon spectrum structure of the carbocation Lewis acid 27 is shown in FIG. 14.

Trimethylene carbonate (0.3063 g, 3 mmol), the carbocation Lewis acid 27 (0.0380 g, 0.1 mmol), triphenylamine (0.0245 g, 0.1 mmol) and benzyl alcohol (10.3 μL, 0.1 mmol) were added to a 10 mL polymerization tube, and finally 1 mL of methylbenzene was added as a solvent; the reaction was stopped after the mixture was magnetically stirred at 100° C. for 24 h; an obtained solution was slowly dropwise added to rectisol, so that a colorless and transparent oily substance was precipitated; and the colorless and transparent oily substance was centrifuged and dried in vacuum to obtain 0.22 g of a colorless and transparent sticky substance, wherein a conversion rate was 75%, a number average molecular weight Mₙ of polytrimethylene carbonate was 2.2 kg/mol, and molecular weight distribution PDI was 1.09; and a hydrogen spectrum is shown in FIG. 15.

### Embodiment 15

The carbocation Lewis acid 18 was prepared as in Embodiment 1.

Trimethylene carbonate (5.1 g, 50 mmol), the carbocation Lewis acid 18 (0.0330 g, 0.1 mmol), triphenylamine (0.0245 g, 0.1 mmol) and phenylpropanol (13.6 μL, 0.1 mmol) were added to a 10 mL polymerization tube, and finally 5 mL of methylbenzene was added as a solvent; the reaction was stopped after the mixture was magnetically stirred at 110° C. for 24 h; an obtained solution was slowly dropwise added to rectisol, so that a colorless and transparent oily substance was precipitated; and the colorless and transparent oily substance was centrifuged and dried in vacuum to obtain 4.8 g of a colorless and transparent sticky substance, wherein a conversion rate was 94%, a number average molecular weight Mₙ of polytrimethylene carbonate was 47 kg/mol, and molecular weight distribution PDI was 1.15.

### Embodiment 16

The carbocation Lewis acid 18 was prepared as in Embodiment 1.

Trimethylene carbonate (5.1 g, 50 mmol), the carbocation Lewis acid 18 (0.0330 g, 0.1 mmol), triphenylamine (0.0245 g, 0.1 mmol) and neopentyl alcohol (8.8 mg, 0.1 mmol) were added to a 10 mL polymerization tube, and finally 5 mL of methylbenzene was added as a solvent; the reaction was stopped after the mixture was magnetically stirred at 110° C. for 24 h; an obtained solution was slowly dropwise added to rectisol, so that a colorless and transparent oily substance was precipitated; and the colorless and transparent oily substance was centrifuged and dried in vacuum to obtain 4.1 g of a colorless and transparent sticky substance, wherein a conversion rate was 80%, a number average molecular weight Mₙ of polytrimethylene carbonate was 40 kg/mol, and molecular weight distribution PDI was 1.20.

### Embodiment 17

The carbocation Lewis acid 18 was prepared as in Embodiment 1.

Trimethylene carbonate (5.1 g, 50 mmol), the carbocation Lewis acid 18 (0.0330 g, 0.1 mmol), triphenylamine (0.0245 g, 0.1 mmol) and 1-pentanol (10.5 mg, 0.1 mmol) were added to a 10 mL polymerization tube, and finally 5 mL of methylbenzene was added as a solvent; the reaction was stopped after the mixture was magnetically stirred at 110° C. for 24 h; an obtained solution was slowly dropwise added to rectisol, so that a colorless and transparent oily substance was precipitated; and the colorless and transparent oily substance was centrifuged and dried in vacuum to obtain 4.4 g of a colorless and transparent sticky substance, wherein a conversion rate was 86%, a number average molecular weight Mₙ of polytrimethylene carbonate was 43 kg/mol, and molecular weight distribution PDI was 1.25.

### Embodiment 18

The carbocation Lewis acid 27 was prepared as in Embodiment 14.

δ-valerolactone (2.25 ml, 25 mmol), the carbocation Lewis acid 27 (0.0380 g, 0.1 mmol), triphenylamine (0.0245 g, 0.1 mmol) and phenylpropanol (13.6 μL, 0.1 mmol) were added to a 10 mL polymerization tube, and finally 1 mL of methylbenzene was added as a solvent; the reaction was stopped after the mixture was magnetically stirred at 20° C. for 16 h; an obtained solution was slowly dropwise added to rectisol, so that a white polymer was precipitated; and the white polymer was centrifuged and dried in vacuum to obtain 1.98 g of a snow-white product, wherein a conversion rate was 88%, a number average molecular weight Mₙ of polyvalerolactone was 24 kg/mol, and molecular weight distribution PDI was 1.15. A hydrogen spectrum of the polyvalerolactone is shown in FIG. 16.

### Embodiment 19

The carbocation Lewis acid 27 was prepared as in Embodiment 14.

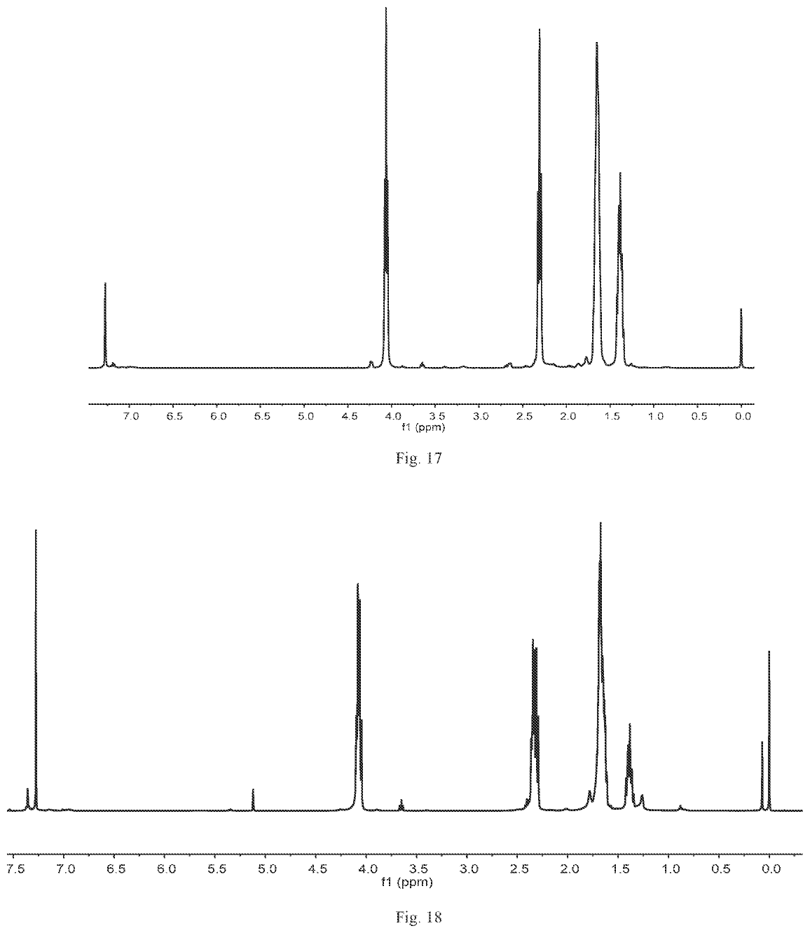

δ-caprolactone (2.6 ml, 30 mmol), the carbocation Lewis acid 27 (0.0380 g, 0.1 mmol), triphenylamine (0.0245 g, 0.1 mmol) and 1-pentanol (10.5 mg, 0.1 mmol) were added to a 10 mL polymerization tube, and finally 1 mL of acetonitrile was added as a solvent; the reaction was stopped after the mixture was magnetically stirred at 20° C. for 18 h; an obtained solution was slowly dropwise added to rectisol, so that a white polymer was precipitated; and the white polymer was centrifuged and dried in vacuum to obtain 2.3 g of a snow-white product, wherein a conversion rate was 98%, a number average molecular weight Mₙ of polycaprolactone was 32 kg/mol, and molecular weight distribution PDI was 1.4. A hydrogen spectrum of the polycaprolactone is shown in FIG. 17.

### Embodiment 20

The carbocation Lewis acid 18 was prepared as in Embodiment 1.

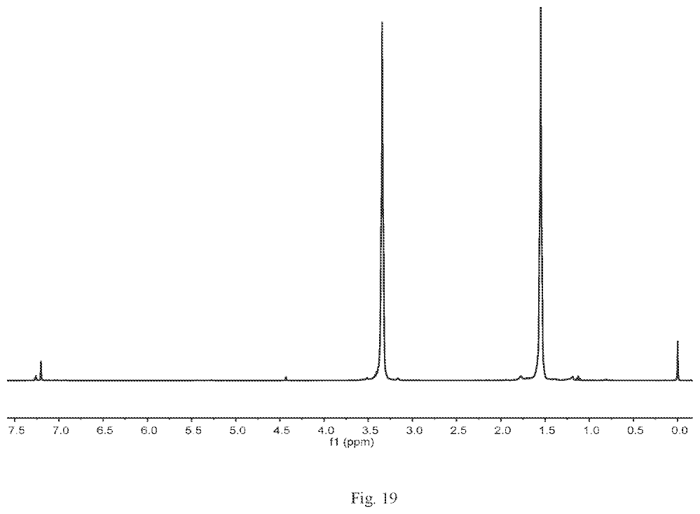

Oxetane (2.6 ml, 30 mmol), the carbocation Lewis acid 18 (0.0330 g, 0.1 mmol), triphenylamine (0.0245 g, 0.1 mmol) and 1-pentanol (10.5 mg, 0.1 mmol) were added to a 10 mL polymerization tube, and finally 1 mL of acetonitrile was added as a solvent; the reaction was stopped after the mixture was magnetically stirred at 60° C. for 6 h; an obtained solution was slowly dropwise added to rectisol, so that a colorless oily substance was produced; and the colorless oily substance was centrifuged and dried in vacuum to obtain 2.3 g of a polyoxetane product, wherein a conversion rate was 88%, a number average molecular weight Mₙ of polycaprolactone was 3.2 kg/mol, and molecular weight distribution PDI was 1.11. An H-nuclear magnetic resonance spectrum of the polyoxetane is shown in FIG. 18.

### Embodiment 21

The carbocation Lewis acid 18 was prepared as in Embodiment 1.

Tetrahydrofuran (2.8 ml, 30 mmol), the carbocation Lewis acid 18 (0.0330 g, 0.1 mmol), triphenylamine (0.0245 g, 0.1 mmol) and benzyl alcohol (10.3 μL, 0.1 mmol) were added to a 10 mL polymerization tube, and finally 1 mL of acetonitrile was added as a solvent; the reaction was stopped after the mixture was magnetically stirred at 70° C. for 5 h; an obtained solution was slowly dropwise added to rectisol, so that a colorless oily substance was produced; and the colorless oily substance was centrifuged and dried in vacuum to obtain 2.8 g of a polytetrahydrofuran product, wherein a conversion rate was 91%, a number average molecular weight Mn of polycaprolactone was 36 kg/mol, and molecular weight distribution PDI was 1.11. An H-nuclear magnetic resonance spectrum of the polytetrahydrofuran is shown in FIG. 19.

1. A ring-opening polymerization method for a cyclic monomer, wherein a Lewis acid-base pair is used to catalyze ring-opening polymerization of the cyclic monomer in the presence of an initiator; the Lewis acid is shown in a formula IV, and the Lewis base is triphenylamine: 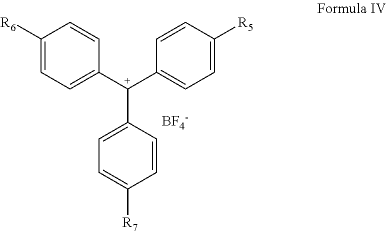
wherein, R₅, R₆ and R₇ are selected from the same or different substituents in hydrogen, fluorine, methyl or methoxyl.

2. The method according to claim 1, wherein the cyclic monomer is selected from cyclic lactone shown in a formula V: 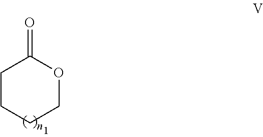
wherein n₁ is an integer selected from 1 to 8;
or the cyclic monomer is selected from cyclic carbonate shown in a formula VI: 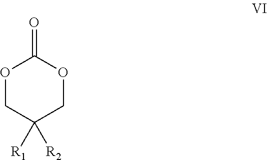
wherein, R₁ and R₂ are selected from the same or different substituents in hydrogen, methyl, fluorine, chlorine and bromine;
or the cyclic monomer is selected from cyclic ether shown in a formula VII: 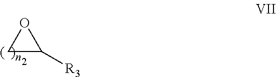
wherein, n₂ is an integer from 1 to 3, and R₃ is selected from hydrogen, methyl, tert-butyl, phenyl or —CH₂OCH₃.

3. The method according to claim 1, wherein the initiator is selected from primary alcohol shown in a formula VIII: 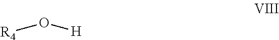
wherein R₄ is selected from benzyl, phenylpropyl, neopentyl or n-pentyl.

4. The method according to claim 1, wherein ring-opening polymerization conditions for the cyclic monomer are as follows: a reaction is carried out in the presence of an organic solvent or in the absence of a solvent in an anhydrous and oxygen-free environment, and a polymer is precipitated by using a precipitation solvent after the reaction is ended,
wherein, a reaction temperature is 20° C. to 110° C. when the reaction is carried out in the presence of the organic solvent, and a reaction temperature is 80° C. to 200° C. when the reaction is carried out in the absence of the solvent.

5. The method according to claim 4, wherein when the reaction is carried out in the presence of the organic solvent, when the organic solvent is dichloromethane, the reaction temperature is 20° C. to 30° C.; when the organic solvent is methylbenzene, the reaction temperature is 20° C. to 110° C.; and when the organic solvent is acetonitrile, the reaction temperature is 20° C. to 80° C.

6. The method according to claim 1, wherein a molar ratio of the cyclic monomer to the Lewis acid to the triphenylamine to the initiator is (30-500):1:1:1.

7. The method according to claim 1, wherein a preparation method of the Lewis acid shown in the formula IV comprises the following steps:
(1) reacting aryl magnesium bromide shown in a formula I with diaryl ketone shown in a formula II in an organic solvent at 30° C. to 70° C. to obtain triarylmethanol shown in a formula III: 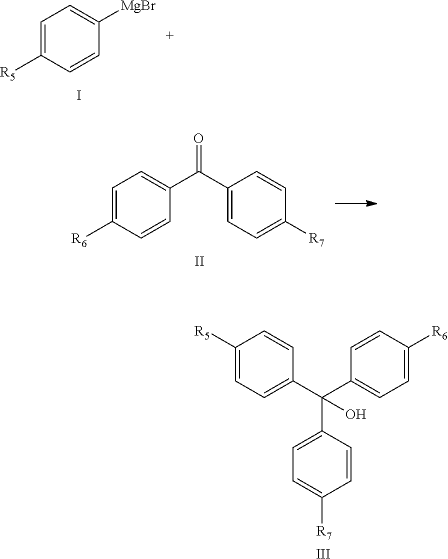
wherein, R₅, R₆ and R₇ are selected from the same or different substituents in hydrogen, fluorine, methyl or methoxyl; and
(2) reacting the product triarylmethanol obtained in the step (1) with HBF₄.Et₂O to obtain the Lewis acid shown in the formula IV.

8. The method according to claim 7, wherein the diaryl ketone shown in the formula II is selected from:

| NO. | Structure |
|---|---|
| 1 | 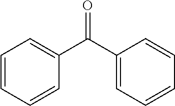 [SMILES: O=C(c1ccccc1)c1ccccc1] |
| 2 | 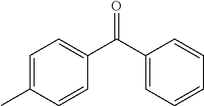 |
| 3 | 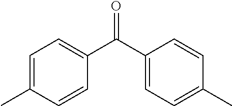 |
| 4 | 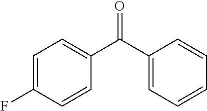 [SMILES: O=C(c1ccccc1)c1ccc(F)cc1] |
| 5 | 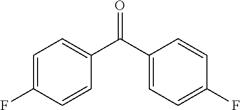 [SMILES: O=C(c1ccc(F)cc1)c1ccc(F)cc1] |
| 6 | 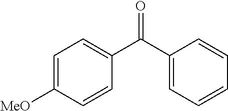 [SMILES: COc1ccc(C(=O)c2ccccc2)cc1] |
| 7 | 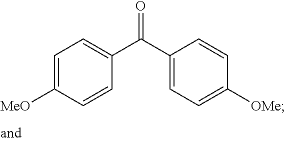 [SMILES: COc1ccc(C(=O)c2ccc(OC)cc2)cc1] |

the triarylmethanol shown in the formula III is selected from:

| NO. | Structure |
|---|---|
| 8 | 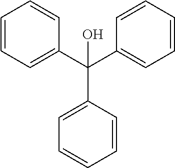 [SMILES: OC(c1ccccc1)(c1ccccc1)c1ccccc1] |
| 9 | 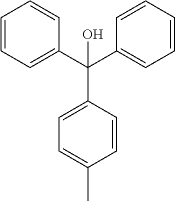 [SMILES: Cc1ccc(C(O)(c2ccccc2)c2ccccc2)cc1] |
| 10 | 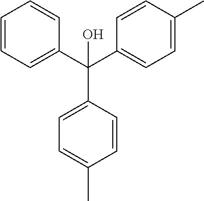 [SMILES: Cc1ccc(C(O)(c2ccccc2)c2ccc(C)cc2)cc1] |
| 11 | 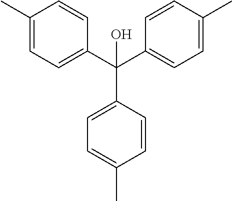 |
| 12 | 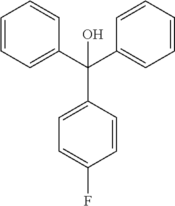 [SMILES: OC(c1ccccc1)(c1ccccc1)c1ccc(F)cc1] |
| 13 | 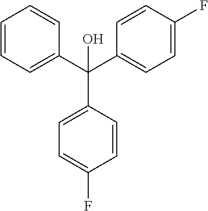 [SMILES: OC(c1ccccc1)(c1ccc(F)cc1)c1ccc(F)cc1] |
| 14 | 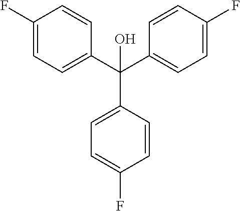 [SMILES: OC(c1ccc(F)cc1)(c1ccc(F)cc1)c1ccc(F)cc1] |
| 15 | 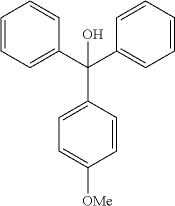 [SMILES: COc1ccc(C(O)(c2ccccc2)c2ccccc2)cc1] |
| 16 | 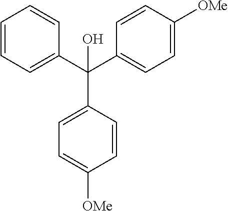 [SMILES: COc1ccc(C(O)(c2ccccc2)c2ccc(OC)cc2)cc1] |
| 17 | 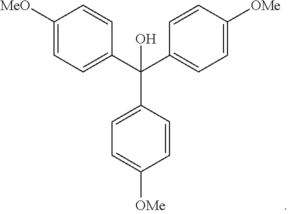 [SMILES: COc1ccc(C(O)(c2ccc(OC)cc2)c2ccc(OC)cc2)cc1] |

9. The method according to claim 7, wherein the step (2) comprises the following specific reaction operations: dissolving the triarylmethanol in anhydrous diethyl ether, cooling to 0° C. to 10° C., and slowly adding dropwise 1.2 to 1.5 molar equivalents of an HBF₄.Et₂O solution while stirring.
